(19) United States
(12) Patent Application Publication
(10) Pub. No.: US 2013/0015340 A1
(43) Pub. Date: Jan. 17, 2013

(54) MULTIPOLE ASSEMBLY HAVING A MAIN MASS FILTER AND AN AUXILIARY MASS FILTER

(71) Applicant: Urs STEINER, Branford, CT (US)

(72) Inventor: Urs STEINER, Branford, CT (US)

(73) Assignee: BRUKER DALTONICS, INC., Billerica, MA (US)

(21) Appl. No.: 13/366,897

(22) Filed: Feb. 6, 2012

Related U.S. Application Data
(60) Provisional application No. 61/508,236, filed on Jul. 15, 2011.

(51) Int. Cl. H01J 49/26

(52) U.S. Cl. 250/281

(57) ABSTRACT

A multipole rod assembly for use in a mass spectrometer has a plurality of rods aligned around and parallel to a common ion optical axis. Each rod consists of two rod pieces that are collinear with one another. Each rod piece has an opposing face that is perpendicular to the axis and faces the other rod. One rod piece has a recess is its face. The rod pieces are physically connected together with an insulating piece located between the two rod pieces to electrically de-couple the rod pieces. The insulating piece has a shape and size that allows it to fit entirely within the recess so that, during operation of the mass spectrometer, the insulating piece is substantially screened from the ion optical axis.

### BACKGROUND

The invention relates to multipole rod assemblies such as frequently used in mass spectrometers, for instance, quadrupoles, hexapoles, octopoles, and the like. Radio frequency (RF) quadrupole mass filters, made from four pole rods essentially aligned parallel to one another, are used to filter ions of merely one single mass-to-charge ratio m/z (frequently also from a finite m/z range), and deflect all other ions entering the mass filter radially outward to the pole rods. They are operated with the two phases of an RF voltage applied alternatively to neighboring rods, and with two anti-polar DC voltages superimposed on the two phases of the RF voltage. For filtering ions of a single mass, the DC voltages amount to about ⅙ of the peak-to-peak RF voltages. The quadrupole mass filter is generally operated in high vacuum, usually better than 10⁻³ Pascal, in order to avoid collisions of the ions with an omnipresent residual gas.

The mixture of ions to be analyzed by the mass filter is accelerated to low kinetic energies of about 1 to 5 electron volts, and the beam is directed, along its axis, into the quadrupole rod system of the mass filter. A low energy is needed for a long flight time inside the rod system. As a rule, a flight time is needed during which the ions are subjected to a minimum of around 100 cycles of the RF voltage to be effectively filtered.

The filtering effect is based upon defocusing by the DC voltage, and focusing by the pseudopotential generated by the RF voltage. Because the focusing strength of the pseudopotential is inversely proportional to the mass-to-charge ratio m/z, and the defocusing strength of the DC is proportional to m/z, ions with low m/z are well focused, while heavy ions are defocused. In addition, however, any quadrupole mass filter shows a low mass cut-off, at an ion mass m/z depending on the RF voltage. In this way, a quadrupole mass filter may be adjusted to just focus ions of a single m/z, while defocusing all others.

Generally, ions of low kinetic energy cannot be transferred well from outside the RF field into the superimposed fields of the mass filter. Mass filters have a narrow “acceptance profile” for ions of low energies, reflecting most of the ions outside the exact axis by the RF stray field (“fringe field”). There are several measures known to overcome this problem. The best known measure is the so-called “Brubaker pre-filter” (see, for example, U.S. Pat. No. 3,129,327 and U.S. Pat. No. 3,235,724). In some assemblies known today all rods of the quadrupole rod system are prolonged by insulated rods with a length of a few centimeters (and shorter than the main rods), and the rods of this pre-filter are supplied with an RF voltage comparable to or less than the RF voltage on the main rods. But the superimposed DC voltages are the same on all rods as an offset, as in an RF-only mode. The acceptance profile at the entrance of the pre-filter and at the entrance of the main filter are both changed in a favorable way, and ions of low kinetic energy can be more easily introduced.

In the prior art, the rods of the pre-filter and the rods of the main filter are spaced apart, and thus electrically de-coupled, by means of intermediate ceramic rings often being configured to match the outer dimensions of the main filter rods and pre-filter rods (FIG. 1A). Sometimes they can also have a smaller outer diameter in a kind of radially setback configuration (FIG. 1B). However, these ceramic rings in such an arrangement as shown have an outer contour edge (dash-dotted circle) exposed to the interior of the mass filter and, more importantly, visible from an ion optical axis which results from the rod alignment. When ions entering the mass filter are diffused radially outward, such as indicated in FIG. 1A with masses m1 and m2, in contrast to m3 that is transmitted, they may hit, apart from the conductive rod surfaces, these outer ceramic edges and cause a surface modification frequently referred to as “ion burn” thereon. For example, material of organic analyte ions may accumulate at the non-conductive edge surface and can cause electrostatic charging when being continuously exposed to diffused ions. Electrostatic charging disturbs the configuration of electric fields for ion confinement and filtering within the multipole thereby complicating the predictability of the mass filter performance and, most often, decreasing significantly the general ion throughput (or ion transmission efficiency) of the mass filter.

Therefore, the need exists to provide multipole assemblies being less impaired by the problems explained above by way of example, and, in particular, to improve performance stability of such multipole assemblies.

### SUMMARY

The following summary is included in order to provide a basic understanding of some aspects and features of the disclosure. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

The invention pertains to a multipole assembly comprising a plurality of main mass filter rods and a plurality of auxiliary mass filter rods, each being located generally in opposing relation to one another and aligned in respect of a common ion optical axis, and a plurality of intermediate insulating pieces, such as ring-shaped washers, for example, made of ceramic or plastic, for electrically de-coupling the plurality of main mass filter rods from the plurality of auxiliary mass filter rods, wherein the plurality of main mass filter rods comprise first front faces and the plurality of auxiliary mass filter rods comprise second front faces, the first front faces and the second front faces being configured as to allow for a nesting arrangement of the plurality of intermediate insulating pieces therebetween, such that the plurality of intermediate insulating pieces is substantially screened from the ion optical axis.

In various embodiments a first front face has a circular recess, preferably having a stepped portion and a tapered portion, for neatly receiving a ring-shaped washer, and a second front face has a circular protrusion, preferably doubly stepped, being adapted to dimensions of the circular recess and the ring-shaped washer resting within the circular recess.

In other embodiments, mirrored to the aforementioned embodiment, a second front face has a circular recess, preferably having a stepped portion and a tapered portion, for neatly receiving a ring-shaped washer, and a first front face has a circular protrusion, preferably doubly stepped, being adapted to dimensions of the circular recess and the ring-shaped washer resting within the circular recess.

In some embodiments, the plurality of main mass filter rods is attached to the plurality of auxiliary mass filter rods. In particular, a first front face may have a tapped hole with an internal thread for receiving a screw with a matching external thread, and an auxiliary mass filter rod may have a bore extending longitudinally with a flange extending radially inward for providing a counter-surface for a head of the screw. In other configurations, the attachment can be brought about by the plurality of intermediate insulating pieces itself.

In further embodiments, the plurality of main mass filter rods and the plurality of auxiliary mass filter rods comprise four rods each. In this manner a quadrupole assembly is created. It is, however, equally possible to provide six rods or eight rods in order to assemble a hexapole or octopole, and the like, respectively.

In one aspect of the invention, the plurality of auxiliary mass filter rods can be attached to the plurality of main mass filter rods on an upstream and/or downstream end in relation to an ion path in a pre-filter and/or post-filter configuration, respectively.

In various embodiments, the pluralities of main mass filter rods and auxiliary mass filter rods comprise rods with a circular cross section.

According to the invention, the intermediate insulating pieces are located at and aligned with the main mass filter rods and the auxiliary mass filter rods in such a way that they are essentially hidden from a line-of-sight from the inside of the mass filter. With such a design, in particular, a higher stability of the ion signal in the mass spectrometer is achieved.

The invention benefits from the effect of the auxiliary electrodes of reducing a DC fringe field effect that ions encounter at the injection into the actual mass filter field, thereby improving the transmission efficiency, and reducing losses in performance caused, for instance, by extensive “ion burn”.

### BRIEF DESCRIPTION OF THE DRAWINGS

The invention can be better understood by referring to the following figures. The components in the figures are not necessarily to scale, emphasis instead being placed upon illustrating the principles of the invention (often schematically). In the figures, like reference numerals designate corresponding parts throughout the different views.

FIGS. 1A and 1B show prior art arrangements where insulator spacers are visible from the interior space between main and auxiliary mass filter rods;

FIGS. 2A to 2H show an exemplary embodiment of the invention in different explosion and cross sectional schematic views where exposure of intermediate insulating pieces is prevented; and

FIG. 3 illustrates another exemplary implementation of the invention.

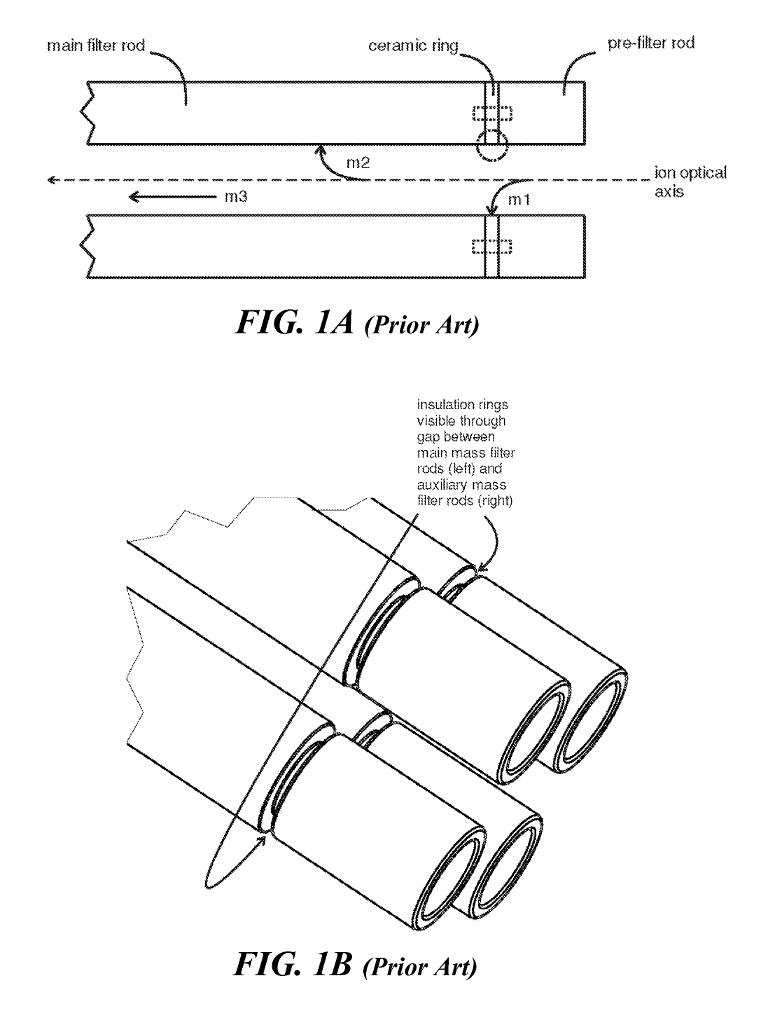

### DETAILED DESCRIPTION

While the invention has been shown and described with reference to a number of embodiments thereof, it will be recognized by those skilled in the art that various changes in form and detail may be made herein without departing from the spirit and scope of the invention as defined by the appended claims.

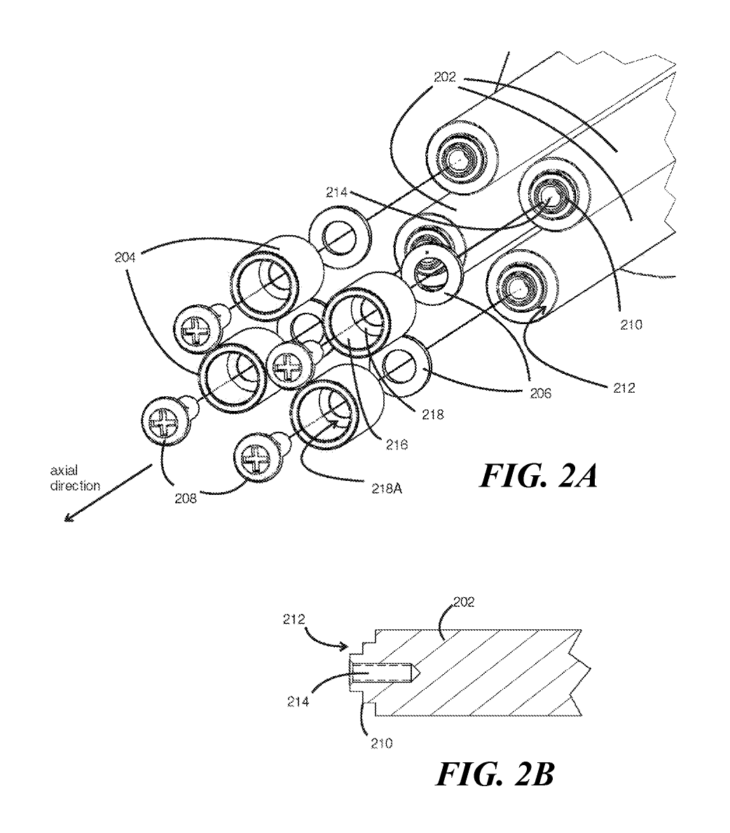

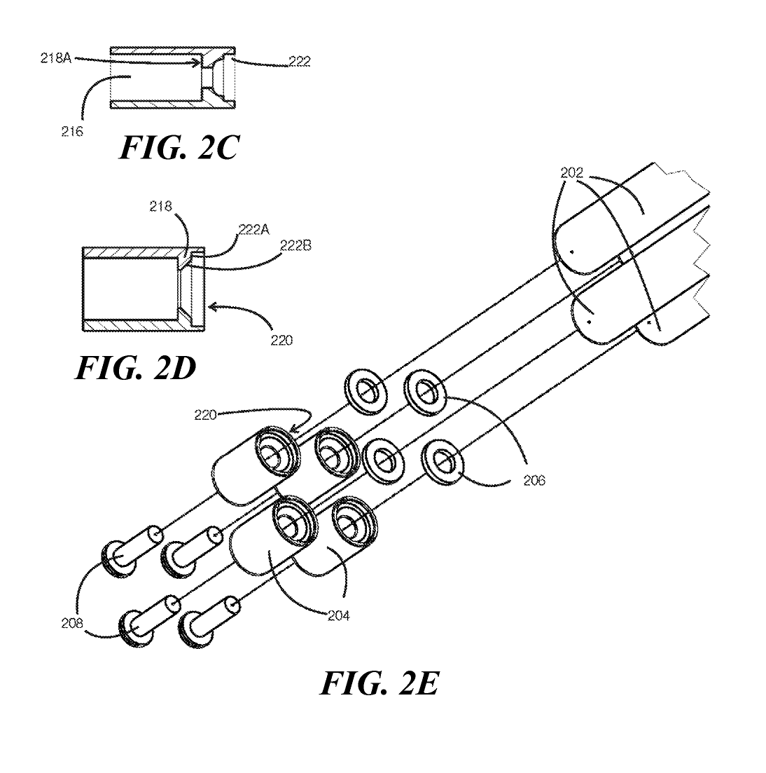

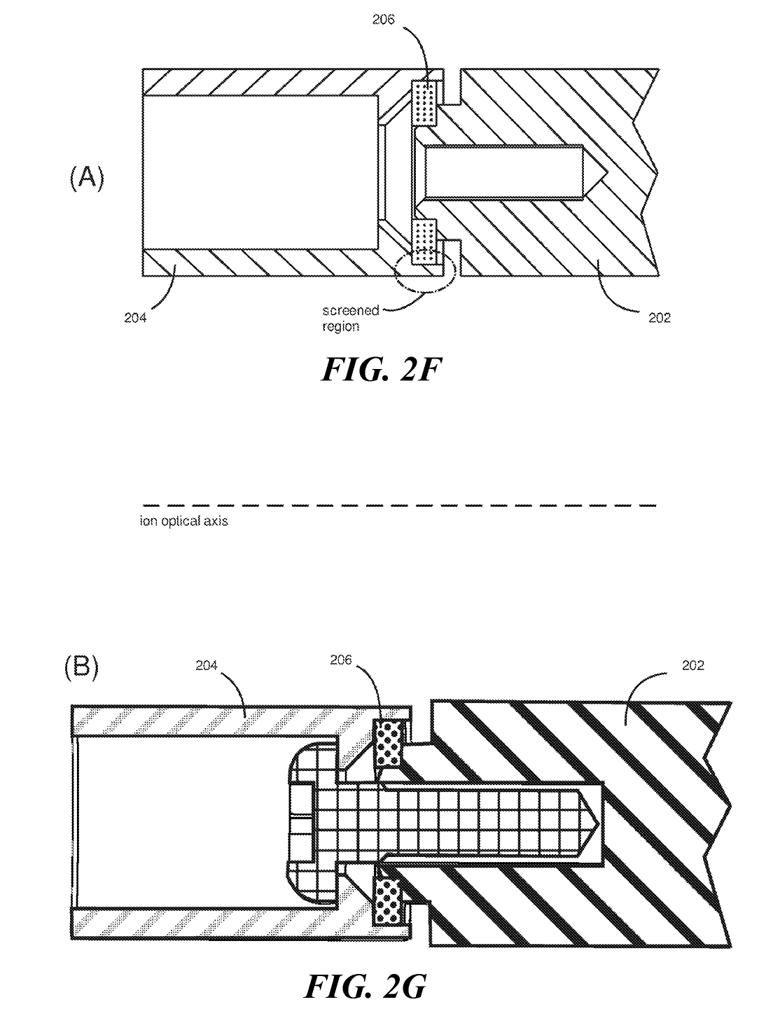

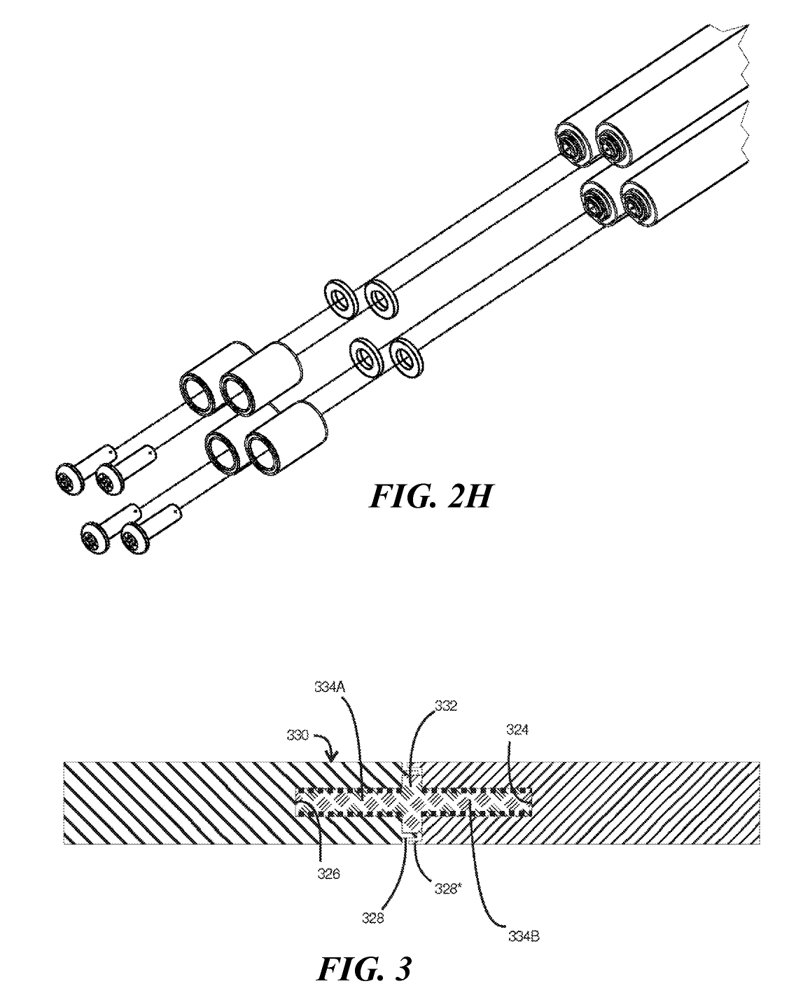

FIG. 2A shows in an exploded schematic a plurality of main mass filter rods 202, a plurality of auxiliary mass filter rods 204, a corresponding plurality of ring-shaped washers 206, and a plurality of screws 208 made of an insulating material, such as ceramic or plastic. The screws 208 may have a central longitudinal bore (not illustrated) extending from the head through to the outer front end of the threaded base for venting purposes.

A circular protrusion 210, doubly-stepped in this example, is machined on the first front faces 212 of the main mass filter rods 202, facing the observer in the illustration of FIG. 2A (see also cross sectional side view of a main mass filter rod in FIG. 2B). The protrusion 210 extends in an axial direction and is dimensioned to match the design feature at opposing second front faces of the auxiliary mass filter rods 204 (not visible in the illustration of FIG. 2A). The protrusion 210, and thereby also the first front face 212, has a central tapped hole 214 extending in the axial direction and comprising an internal thread for a mating engagement with the external thread of the screws 208 displayed (lines indicate the direction of attachment). By means of the screws 208 made of insulating material the auxiliary mass filter rods 204 can be attached to, and be supported by, the main mass filter rods 202 avoiding any electrical contact therebetween.

The embodiment with the screws 208, however, is given by way of example only. Other means of attaching the auxiliary mass filter rods 204 to the main mass filter rods 202, such as gluing or clamping, are also conceivable. In fact, the auxiliary mass filter rods 204 could be mounted and supported completely independent of the main mass filter rods 202, wherein then the positioning of the rods to one another would focus on the alignment of the rods and the alignment of the corresponding ion optical axes.

The auxiliary mass filter rods 204 have a longitudinal bore 216 extending over the whole axial length, in this example, giving the auxiliary mass filter rod 204 a hollow cylindrical shape. At some point along the longitudinal extension, the auxiliary mass filter rods 204 have an internal flange 218 protruding radially inward and providing a resting surface 218A for the underside of the heads of the screws 208. Thus, the flange surface facing in an axial direction may serve as a counter-surface when the screws 208 are drawn tight during the assembly of the rods.

FIG. 2E shows the arrangement of FIG. 2A from another perspective where the second front faces 220 of the auxiliary mass filter rods 204 face the observer, and the first front faces of the main mass filter rods are not visible (see also cross sectional side view of two exemplary implementations FIG. 2C and FIG. 2D of an auxiliary mass filter rod on top). As can be seen the flange 218 machined in the interior of the auxiliary mass filter rods 204 is positioned in a setback configuration from the second front faces 220 such that a circular recess 222 (that could also be called a “collar”) in the region of the second front face 220 of the bore 216 is created.

The circular recess 222 located at the side of the flange 218 facing the main mass filter rods 202 when attached thereto comprises a stepped portion 222A and a tapered portion 222B. The difference between the two illustrated exemplary embodiments shown in FIGS. 2C and 2D of the auxiliary mass filter rods 204 is that the tapered portion features a curved side face in FIG. 2C, whereas FIG. 2D comprises a conically tapered portion (or in other words, a straight face). The distance of the stepped portion 222A to the second front face 220, and the depth of the tapered portion 222B in an axial direction, is favorably adapted to the thickness of the ring-shaped washer 206, so that in an assembled condition the outer side edge of the washer 206 is covered or screened from the interior of the multipole assembly while, at the same time, ensuring electrical insulation between the main mass filter rods 202 and the auxiliary mass filter rods 204. In the example shown, the side wall of the circular recess 222 extends over the whole circumference of the auxiliary mass filter rod 204 as this rotationally symmetric design is rather easy to manufacture. However, it would suffice to provide an axially protruding part of the side wall (and hence a screening of the washer 206) just in the region where the outer surface of the auxiliary mass filter rods 204 faces radially inward to the ion optical axis so that it would experience the highest ion exposure.

FIGS. 2F and 2G show two variants in an assembled state in cross sectional views, the screws (illustrated only in FIG. 2G) are hidden inside the bore 216 of the auxiliary mass filter rods 204, and the washers 206 are settled inside the ring space provided by the collar at the second front faces 220 of the auxiliary mass filter rods 204, therein contacting inner circumferential surfaces of the main mass filter rods 202 and the auxiliary mass filter rods 204, so that they are not visible from an ion optical axis but are screened therefrom (dash-dotted ellipse in FIG. 2F). In the embodiments shown in FIGS. 2F and 2G, the adjacent main mass filter rods 202 and auxiliary mass filter rods 204 have a gap between them at the outer circumferential surface, the magnitude of which is illustrated by way of example only. The gap may be smaller or even larger, as long as a screening effect of the washer 206 is obtained. A difference between the variants shown in FIGS. 2F and 2G, illustrated by way of example, is that the outer diameter of the main mass filter rods 202 and the outer diameter of the auxiliary mass filter rods do not have to match (rods 202 being larger in this case), but may be slightly different.

With this design as presented, no ions being diffused during their transit through the mass filter may impinge on the insulating material of the washers 206, but will rather be absorbed by the conductive surfaces of the rods 202, 204. As a result, the danger of electrostatic charging is reduced significantly.

For the sake of completeness FIG. 2H shows a further perspective of the aforementioned multipole arrangement as an exploded illustration.

FIG. 3 shows another schematic of an embodiment with differently designed first and second front faces of the main mass filter rods and auxiliary mass filter rods. Since the design of the front faces can generally be mirrored, that is, one design feature can be realized at the first front face of a main mass filter rod, whereas the corresponding other design feature can be realized at the second front face of an auxiliary mass filter rod, and vice versa without changing the utility, in the following description as well as in FIG. 3 the two types of rods will not be further identified.

One of the front faces has a doubly recessed structure wherein the second inner recess 324 (resembling a tapped hole) comprises an internal thread for a mating interaction with a complementary external thread. The opposing front face has a tapped hole 326, likewise comprising an internal thread. Furthermore, the opposing front face features an axially protruding ring collar 328 being spaced apart in a radial direction from the outermost circumferential contour line 330 (being illustrated flush for both rods), so as not to interfere with an axially protruding ring collar 328*.

The intermediate insulating piece, in the example shown, comprises a disk-shaped main body 332 and two extensions 334A, 334B axially protruding therefrom, generally in the shape of cylinders having each an external thread thereon. The dimensions of the axially protruding extensions 334A, 334B are adapted on one side of the main body 332 to that of the second recess 324 and on the other side to that of the tapped hole 326, so that by screwing them together they tightly fit into second recess 324 and tapped hole 326, respectively. The dimension of the main body 332 is adapted such as to provide sufficient spacing between the axially protruding parts 328, 328* on the two opposing front faces for effecting electrical insulation therebetween.

Main mass filter rods and auxiliary mass filter rods, according to the embodiment illustrated, can be assembled by first screwing one of the axially protruding extensions 334A, 334B into the internally threaded tapped hole 326 of one of the mass filter rods, and then screwing this sub-assembly with the other axially protruding extension 334A, 334B into the internally threaded second recess 324. By such a design as displayed, the mass filter rods can be attached to one another in an electrically insulating manner while, at the same time, providing a favorable screening of the intermediate insulating piece against ion exposure originating from the interior of the mass filter assembly by means of the axially protruding collars 328, 328*.

The rods shown in the figures have a round circular cross section. It goes without saying that the principle of the invention can be extended to include rods having a different cross section, such as a section-wise hyperbolic cross section. Furthermore, the invention has been explained referring to conductive rods. However, it will be clear from the context of the disclosure that the invention is applicable also to other conductive electrode designs conceivable.

It will be understood that various aspects or details of the invention may be changed, or that different aspects disclosed in conjunction with different embodiments of the invention may be readily combined if practicable, without departing from the scope of the invention. Furthermore, the foregoing description is for the purpose of illustration only, and not for the purpose of limiting the invention, which is defined solely by the appended claims.

What is claimed is:

1. A multipole assembly comprising:
a plurality of first mass filter rods and a plurality of second mass filter rods aligned around and parallel to a common ion optical axis, each of the first mass filter rods being located collinearly with one of the of the second mass filter rods and having a face that is perpendicular to the axis, faces the one second mass filter rod and has a recess therein; and
a plurality of insulating pieces, one insulating piece being located between each first mass filter rod and its collinear second mass filter rod for electrically de-coupling the first mass filter rods from the second mass filter rods, each insulating piece having a shape and size that allows it to fit entirely within the recess in the first mass filter rod face, so that each insulating piece is screened from ions travelling in a direction perpendicular the ion optical axis.

2. The assembly of claim 1, wherein each of the plurality of insulating pieces comprises a ring-shaped washer.

3. The assembly of claim 2, wherein the recess in each first mass filter rod face is circular for receiving a ring-shaped insulating washer, and wherein each of the second mass filter rods has a face that is perpendicular to the axis, faces the one collinear first mass filter rod and has a circular protrusion therefrom, the protrusion having an outer diameter less than an inner diameter of the recess.

4. The assembly of claim 3, wherein the circular protrusion is doubly stepped.

5. The assembly of claim 3, wherein the circular recess has a stepped portion and a tapered portion.

6. The assembly of claim 1, wherein each of the plurality of first mass filter rods is physically attached to one of the plurality of second mass filter rods.

7. The assembly of claim 6, wherein each first mass filter rod face has a tapped hole therein for receiving a screw with a head, and wherein each second mass filter rod has a bore extending longitudinally therethrough with a flange extending radially inward for providing a counter-surface for the screw head.

8. The assembly of claim 6, wherein each of the plurality of first mass filter rods is physically attached to one of the plurality of second mass filter rods by one of the insulating pieces.

9. The assembly of claim 1, wherein each of the plurality of insulating pieces is fabricated from one of ceramic and plastic.

10. The assembly of claim 1, wherein the plurality of first mass filter rods comprises four rods and the plurality of second mass filter rods comprises four rods.

11. The assembly of claim 1, wherein the each of the plurality of first mass filter rods is an auxiliary mass filter rod and each of the plurality of second mass filter rods is a main mass filter rod to form a pre-filter configuration.

12. The assembly of claim 1, wherein the each of the plurality of first mass filter rods is a main mass filter rod and each of the plurality of second mass filter rods is an auxiliary mass filter rod to form a post-filter configuration.

13. The assembly of claim 1, wherein each of the plurality of first mass filter rods and each of the plurality of second mass filter rods has a circular cross section.
